(19) United States
(12) Patent Application Publication
(10) Pub. No.: US 2011/0275349 A1
(43) Pub. Date: Nov. 10, 2011

(54) Mobile Phone Message Archiving System

(75) Inventor: Dennis Mendiola, Manila (PH)

(73) Assignee: VOXP PTE. LTD., Singapore (SG)

(21) Appl. No.: 13/128,230

(22) PCT Filed: Nov. 6, 2009
(86) PCT No.: PCT/SG2009/000412

§ 371 Date: Jul. 25, 2011

Related U.S. Application Data
(60) Provisional application No. 61/111,758, filed on Nov. 6, 2008.

(51) Int. Cl. H04W 4/14

(52) U.S. Cl. 455/412.1

(57) ABSTRACT

A message archiving system (100) comprising a message archiving server (102), at least one message service centre interface (106); and at least one POI interface (108). When a mobile phone number of a participating user (116) is designated as the receiver of a mobile phone-based message (120) communicated by way of at least one message service centre (110) associated with a message service centre interface (106) or by way of at least one POI (109) associated with a POI interface (108), the message service centre interface (106) or POI interface (108), as applicable, operates to provide a copy of the mobile phone-based message (120) to the message archiving server (102) for storage.

### FIELD OF THE INVENTION

The invention relates to a mobile phone message archiving system. The mobile phone message archiving system is particularly suited to the archiving of messages sent to a subscriber from subscribers of at least two telecommunications carriers, such that the subscriber is able to see a complete record of all such messages irrespective of whether they received the messages by way of their message communication device or not.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Communication by way of mobile phone messaging systems is increasing dramatically. At the same time, mobile phones—particularly those available in developing countries—do not have the memory capacity to store a large number of messages. This means that users often have to make decisions about which messages to keep. In other situations, the mobile phone may make the decision for them by deleting the oldest message when a new message is received. This can lead to problems in situations where such messages include registration information or other information necessary to the business or personal well-being of the user.

A solution to this problem is to install an application in the mobile phone which allows for messages sent and received by the mobile phone to be transmitted as data to a remote location. This remote location ideally has high storage capacity to allow for large numbers of messages to be stored. Such a remote location is then accessible by the person in possession of the mobile phone through alternate means, such as by way of an internet website. In this manner, the possessor of the mobile phone has a record of all messages sent and received by the mobile phone—even those already deleted from the memory of the mobile phone.

The problem with this situation is that not all messages intended for the possessor of the mobile phone may actually reach the mobile phone. For instance, in some developing countries, such as the Philippines, messages may be kept by the telecommunications carrier for a predetermined period of time due to volume/capacity issues. If it is not possible for the telecommunications carrier to deliver the message to the intended recipient within this predetermined period of time, the message is simply deleted from the telecommunications carrier's systems. In such a situation, the possessor of the mobile phone is not aware that a message has ever been sent while at the same time the person who sent the message is unaware that the message has not been received by the possessor of the mobile phone.

Another problem with the approach of installing an application on one's mobile phone is that this requires an extra step of actually requiring the user to download and install the application. This is an additional step that would slow down people's adoption of the service. Also, this solution requires that the mobile phone have internet connection which still in many places around the world is not the case, either because the network is outdated or more likely, because the users don't know how to configure their phones to access the internet.

As one means of dealing with this problem, it is possible to capture the message at the Short Message Service Centre (“SMSC”) rather than the mobile phone. However, the applicants have come to understand that this “solution to the problem” is ineffective as it misunderstands the true nature of the problem. The true nature of the problem is better explained with reference to an example as depicted pictorially in FIG. 1.

Sender 10 is a subscriber of telecommunications carrier 12. Receiver 14 is a subscriber of telecommunications carrier 16. Subscriber 12 and receiver 14 both possess a mobile phone 18a, 18b. Mobile phone 18a is able to communicate with other communication devices by way of the mobile phone network 20 operated by telecommunications carrier 12. Mobile phone 18b is able to communicate with other communication devices by way of the mobile phone network 22 operated by telecommunications carrier 16.

Both mobile phone networks 20, 22 have an SMSC 24a, 24b and a Messaging Service Centre (“MSC”) 26a, 26b for handling message communication.

With this in mind, when the sender 10 operates to send a message 28 to the receiver 14 by way of their mobile phone 18a, the message 28 is directed firstly to SMSC 24a. SMSC 24a then forwards the message 28 directly to the receiver 14 by way of MSC 24b. In this situation, the MSC 24b does not interact with the message 28 in any way other than to note its passing by incrementing a counter of messages received which is later used by the telecommunications carrier 16 for reconciling payment between the telecommunications carriers 12, 16.

Thus, as the message 28 does not pass through SMSC 28, any system operating to obtain message information solely from the SMSC of one telecommunication network will not obtain a complete record of all messages sent to their subscribers. Rather information on any inter-telecommunication network messages will be missing.

It is therefore an object of the present invention to provide a system whereby mobile phone messages may be archived in a manner that allows for capture of mobile phone messages intended for a subscriber of a first telecommunications network that have been sent by subscribers of at least one second telecommunications network.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention, there is a message archiving system comprising:
a message archiving server;
at least one messaging service centre interface; and
at least one POI interface;
   where, when a mobile phone number of a participating user is designated as the recipient of a mobile phone-based message communicated by way of at least one messaging service centre associated with a messaging service centre interface or by way of at least one POI associated with a POI interface, the messaging service centre interface or POI interface, as applicable, operates to provide a copy of the mobile phone-based message to the message archiving server for storage.

The message archiving system may be modified to also copy those mobile-phone based message for which the participating user is designated as the sender.

Each messaging service centre interface and each POI interface are, ideally, in data communication with a temporary storage medium for the storing of the copies of the mobile phone-based messages, each temporary storage medium operable to forward the copies of mobile phone-based messages to the message archiving server at preset times. To regulate the flow of message traffic to the message archiving server, each temporary storage medium may have differing preset times at which it is to forward the copies of mobile phone-based messages to the message archiving server.

Preferably, a user is designated a participating user following the communication of an opt-in message to the message archiving server.

The participating user may view copies of mobile phone-based messages related to the participating user, as stored by the message archiving server, by way of:
a website interface;
a downloadable electronic file; and/or
an external application.

The message archiving system may be adapted to record short message service messages, multimedia message service messages or both.

The copied mobile phone-based messages may be sorted by the message service centres and POI interfaces. Alternatively, the copied mobile phone-based messages are sorted by the message archiving server.

In accordance with a second aspect of the invention there is a message archiving system comprising:
a message archiving server;
at least one messaging service centre interface; and
at least one POI interface;
   where, a copy of all mobile phone-based message by way of at least one messaging service centre associated with a messaging service centre interface or by way of at least one POI associated with a POI interface, are provided by the message service centre or POI interface, as applicable, to the message archiving server, the message archiving server thereafter operable to store only those messages for which a mobile phone number of a participating user is specified as the recipient.

In accordance with a third aspect of the invention there is a message archiving server in communication with at least one messaging service centre interface and at least one POI interface where, when a mobile phone number of a participating user is specified as the recipient of a mobile phone-based message by way of at least one messaging service centre associated with a messaging service centre interface or by way of at least one POI associated with a POI interface, the messaging archiving server receives for storage a copy of the mobile phone-based message from the messaging service centre interface or POI interface, as applicable.

In accordance with a fourth aspect of the invention there is a message archiving server in communication with at least one messaging service centre interface and at least one POI interface where, the message archiving server is operable to receive a copy of each mobile phone-based message from each messaging service centre interface and POI interface and, thereafter, operable to store only those messages for which a mobile phone number of a participating user is specified as the recipient.

Further aspects of the invention relate to software stored on a computer readable medium to operate a mobile phone-based message archiving system and a method for archiving mobile phone-based messages.

### BRIEF DESCRIPTION OF THE DRAWINGS

The invention will now be described, by way of example only, with reference to the accompanying drawings, in which:

FIG. 1 is a schematic representation of the prior art described above.

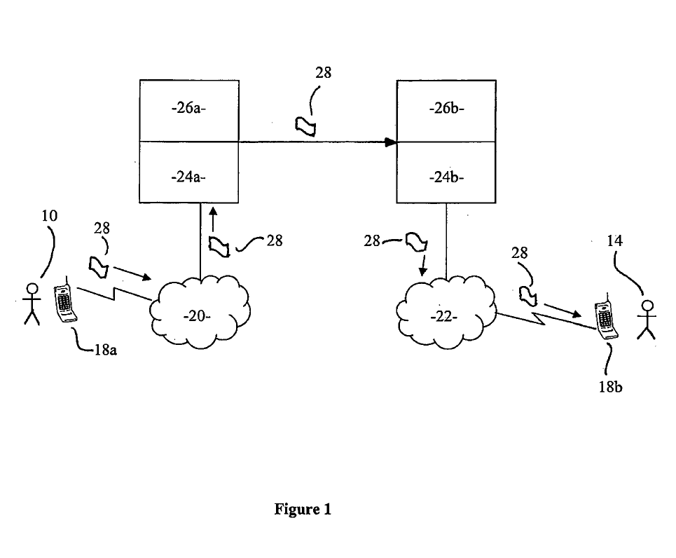

FIG. 2 is a schematic representation of a first embodiment of the invention.

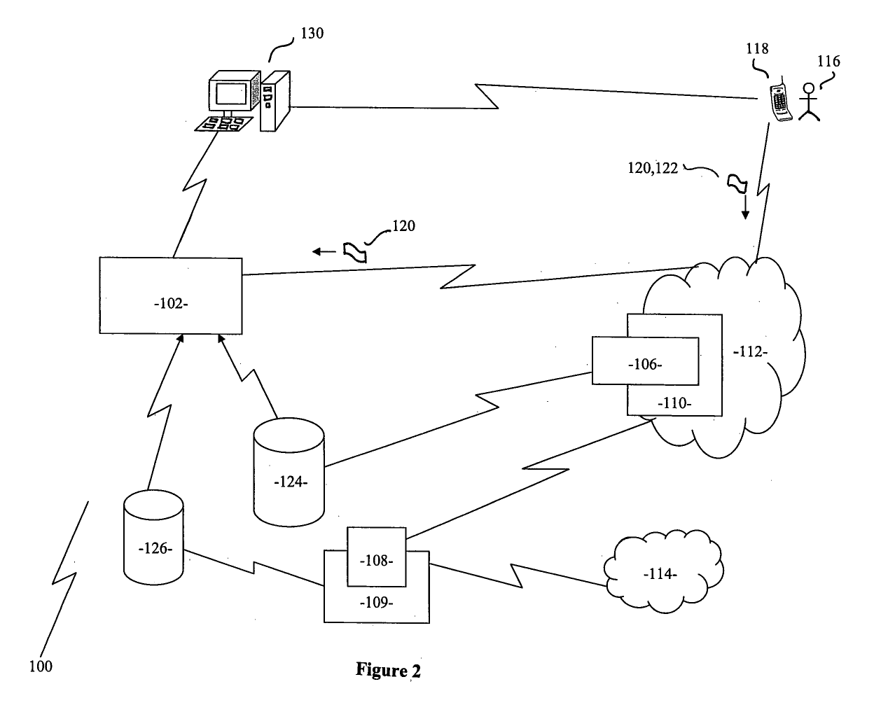

FIG. 3 is a schematic representation of a second embodiment of the invention.

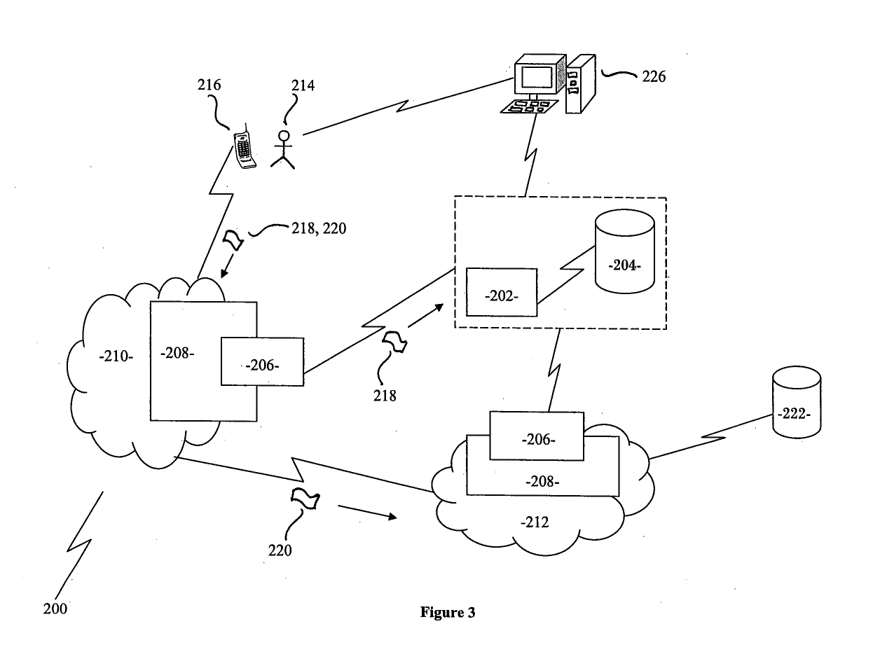

### PREFERRED EMBODIMENTS OF THE INVENTION

In accordance with a first aspect of the invention there is a mobile phone message archiving system 100 comprising:
a message archiving server 102;
a message archiving database 104;
at least one SMSC interface 106; and
at least one POI interface 108.

In this embodiment, the message archiving server 102 is integrated with the message archiving database 104. The message archiving server 102 is in data and control communication with each SMSC interface 106 and each POI interface 108.

Each SMSC interface 106 interacts with a SMSC 110 of a telecommunications network 112 in a manner that all SMS messages received by the SMSC 110 are able to be inspected by the SMSC interface 106.

Each Point Of Interconnect (“POI”) interface 108 interacts with a physical POI 109 between the telecommunications carrier 112 and an external telecommunications carrier 114 in a manner that all SMS messages that pass through the POI 109 are able to be inspected by the POI interface 108.

This embodiment will best be described in the context of its intended use.

A subscriber 116 of telecommunications carrier 112 uses a mobile phone 118 to compose an opt-in SMS message 120. The opt-in SMS message 120 is sent to a destination address (not shown) associated with the message archiving server 102. On receipt of the opt-in SMS message 120, the message archiving server 102 takes appropriate steps to track SMS messages sent to and from mobile phone 118. These steps include:
creating and allocating a tracking record for the subscriber 116 in the message archiving database 104;
notifying each SMSC interface 106 to record message information destined for or originating from the subscriber 116; AND
notifying each POI interface 108 to record message information destined for the subscriber 116.

On receiving notification that it must record message information destined for or originating from the subscriber 116, the SMSC interface 106 adds the mobile phone number of the subscriber's 116 mobile phone 118 to its watch list (not shown). Each SMS message 122 that is subsequently routed by the SMSC 110 is inspected by the SMSC interface 106 to determine the mobile phone numbers of the mobile phone sending the SMS message 122 and the mobile phone to which the SMS message 122 is destined. If either of these mobile phone numbers are included on the watch list, the SMSC interface 106 copies the SMS message 122 to a temporary storage device 124.

Similarly, on receiving notification that it must record message information destined for the subscriber 116, the POI interface 108 adds the mobile phone number of the subscriber's 116 mobile phone 118 to its watch list (also not shown). Each SMS message 122 that is subsequently routed through the POI 109 is inspected by the POI interface 108 to determine the mobile phone number of the mobile phone to which the SMS message 122 is destined. If this mobile phone number is included on the watch list, the POI interface 108 copies the SMS message 122 to a temporary storage device 126.

At periodic intervals each SMSC interface 106 will forward each SMS message 122 copied to the temporary storage device 124 to the message archiving server 102. At further periodic intervals, each POI interface 108 will forward each SMS message 122 copied to the temporary storage device 126 to the message archiving server 102. The times of transmission of the SMS message 122 data by each SMSC interface 106 and each POI interface 108 are staggered to alleviate congestion at the message archiving server 102 as much as possible.

Each time the message archiving server 102 receives SMS message 122 data (whether from a SMSC interface 106 or from a POI interface 108) the message archiving server 102 operates to sort the message data so received. This message data is first sorted based on the mobile phone number of the intended recipient. Once sorted, each sorted message is analysed in turn and cross-referenced against the tracking records stored in the message archiving database 104.

If a tracking record is found that cross-references to the mobile phone number of the intended recipient of the message, the message is stored in the message archiving database 104 and associated with the appropriate tracking record. The message is then deleted from the sorted list.

Once the sorted list has been traversed in full, it is re-sorted according to the mobile phone number of the sender. Each sorted message is again analysed in turn and cross-referenced against the tracking records stored in the message archiving database 104. If a tracking record is found that cross-references to the mobile phone number of the sender of the message, the message is stored in the message archiving database 104 and associated with the appropriate tracking record.

At any time during this repetitive process, the subscriber 116 may log on to the message archiving server 102 by way of its website interface 130. Once the subscriber 116 has completed the necessary authorisation requirements of the website interface 130, the subscriber will then be presented with a complete list of all messages currently recorded in the message archiving database 104 associated with the tracking record previously allocated to the subscriber 116. The subscriber may then view, delete or otherwise manipulate the messages displayed as would be readily apparent to the person skilled in the art.

In accordance with a second embodiment of the invention, there is a mobile phone message archiving system 200 comprising:
a message archiving server 202;
a message archiving database 204; and
a plurality of SMSC interfaces 206.

In this embodiment, the message archiving server 202 is integrated with the message archiving database 204. The message archiving server 202 is in data and control communication with each SMSC interface 206.

Each SMSC interface 206 interacts with a SMSC 208 of a telecommunications network 210, 212 in a manner that all SMS messages received by the SMSC 208 are able to be inspected by the SMSC interface 206.

This embodiment will now be described in the context of its intended use.

A subscriber 214 of telecommunications network 210 uses a mobile phone 216 to compose an opt-in SMS message 218. The opt-in SMS message 218 is sent to a destination address (not shown) associated with the message archiving server 202. On receipt of the opt-in SMS message 218, the message archiving server 202 takes appropriate steps to track SMS messages sent to and from mobile phone 216. These steps include:
creating and allocating a tracking record for the subscriber 214 in the message archiving database 204;
notifying each SMSC interface 206 attached to an SMSC 208 of telecommunications network 210 to record message information destined for or originating from the subscriber 214; AND
notifying each SMSC interface 206 attached to an SMSC 208 associated with a telecommunications network 218 other than telecommunications network 210 to record message information destined for subscriber 214.

On receiving notification that it must record message information destined for or originating from the subscriber 214, each SMSC interfaces 206 adds the mobile phone number of the subscriber's 214 mobile phone 216 to its watch list (not shown). Each SMS message 220 that is subsequently routed by their associated SMSC 208 is then inspected by the SMSC interface 206.

In the case of SMSC interfaces 206 attached to SMSCs 208 of telecommunications network 210, this inspection determines the mobile phone number of both the sender and receiver of the SMS message 220. If either of these mobile phone numbers is included on the watch list, the SMSC interface 206 copies the SMS message 220 to its respective temporary storage device 222.

In the case of all other SMSC interfaces 206 (ie. those attached to SMSCs 208 of telecommunication networks 218), this inspection determines the mobile phone number of the receiver of the SMS message 220. If this mobile phone number is included on the watch list, the SMSC interface 206 copies the SMS message 220 to its respective temporary storage device 222.

At periodic intervals each SMSC interface 206 will forward each SMS message 220 copied to its respective temporary storage device 222 to the message archiving server 202. The times of transmission of the SMS message 220 data by each SMSC interface 206 are staggered to alleviate congestion at the message archiving server 202 as much as possible.

Each time the message archiving server 202 receives SMS message 220 data, the message archiving server 202 operates to sort the message data so received. This message data is first sorted based on the mobile phone number of the intended recipient. Once sorted, each sorted message is analysed in turn and cross-referenced against the tracking records stored in the message archiving database 204.

If a tracking record is found that cross-references to the mobile phone number of the intended recipient of the message, the message is stored in the message archiving database 204 and associated with the appropriate tracking record. The message is then deleted from the sorted list.

Once the sorted list has been traversed in full, it is re-sorted according to the mobile phone number of the sender. Each sorted message is again analysed in turn and cross-referenced against the tracking records stored in the message archiving database 204. If a tracking record is found that cross-references to the mobile phone number of the sender of the message, the message is stored in the message archiving database 204 and associated with the appropriate tracking record.

At any time during this repetitive process, the subscriber 214 may log on to the message archiving server 202 by way of its website interface 226. Once the subscriber 214 has completed the necessary authorisation requirements of the website interface 226, the subscriber will then be presented with a complete list of all messages currently recorded in the message archiving database 204 associated with the tracking record previously allocated to the subscriber 214. The subscriber 214 may then view, delete or otherwise manipulate the messages displayed as would be readily apparent to the person skilled in the art.

It should be appreciated by the person skilled in the art that the above invention is not limited to the embodiment described. In particular, the following modifications and improvements may be made without departing from the scope of the present invention:
The embodiments described above may be modified such that the system only captures messages intended for a subscriber and not messages both intended for and sent by the subscriber.
The message archiving database and the message archiving server may be co-located or remotely located relative to each other connected by a data communication link.
One SMSC interface may interact with multiple SMSCs. This is a particularly advantageous arrangement in situations where SMSCs are clustered.
One POI interface may interact with multiple POIs. For instance, in a situation where multiple POIs may be arranged around a major communications link, a single POI interface may interact with all these POIs.
The subscriber may opt-in through other methods than the sending of an SMS message. For instance, the subscriber may provide the required details through the website associated with the message archiving server.
Similarly, the subscriber need not access the website in order to obtain the archived message information. For instance, the information may be accessible as a downloadable file or may be downloaded directly to an application installed on a subscriber's computer.
The systems as described above may be modified such that all messages are captured and copied. In this situation, it is not necessary for the message archiving server to notify the SMSC interfaces (and POI interfaces in the case of the first embodiment) of the subscriber's mobile phone number. In such a situation it is envisaged that the message archiving server will perform the cross-references described above.
Each SMSC interface may sort the messages as described above instead of the message archiving server prior to storing in the temporary storage device. In this manner, the message archiving server may simply operate to correlate the sorted message information received from each SMSC interface at the time of receipt and store it in the message archiving database.
The sorting procedure may be modified from that described above. For instance, the sorting procedure may not involve deletion of records after matching. In this instance, it may be that the totality of the records are sorted twice (once based on the sender's mobile phone number and once based on the recipient's mobile phone number). In yet a further variation, the messages may be sorted once (based either on the sender's mobile phone number or the recipient's mobile phone number). Thereafter, as each record is assessed in turn, a cross-reference check is made firstly based on the sender's mobile phone number and then based on the recipient's mobile phone number.
In yet a further alternative variation, no sorting of the messages may occur. Rather, each record may be assessed in turn with a cross-reference check being made firstly based on the sender's mobile phone number and then based on the recipient's mobile phone number.
In performing cross-references, it is important to implement procedures whereby if both the recipient and the sender have opted-in to have their messages archived a copy of the message is associated with both accounts and not simply the first mobile phone number used for a cross-reference.
Messages may be further categorised into sent and received messages so as to allow the subscriber to view messages sent separately from those received.
A single temporary storage device may be used by multiple SMSC interfaces and/or POI interfaces. Alternatively, there may be a single temporary storage device used by all SMSC interfaces and/or POI interfaces. This single temporary storage device may perform some of the processing otherwise required by the SMSC interfaces, POI interfaces and/or message archiving server prior to forwarding the data to the message archiving server.
While the invention has been described above in the context of SMS messages 40. The invention can be easily modified to handle any other mobile phone-based messaging system, such as MMS messages.

It should be appreciated by the person skilled in the art that the modifications and improvements mentioned above, not being mutually exclusive, can be combined to form yet further embodiments considered within the scope of the present invention.

1. A message archiving system comprising:
a message archiving server;
at least one messaging service centre interface; and
at least one POI interface;
where, when a mobile phone number of a participating user is designated as the recipient of a mobile phone-based message communicated by way of at least one messaging service centre associated with a messaging service centre interface or by way of at least one POI associated with a POI interface, the messaging service centre interface or POI interface, as applicable, operates to provide a copy of the mobile phone-based message to the message archiving server for storage.

2. A message archiving system according to claim 1, where when a participating user is designated as the sender of a mobile phone-based message communicated by way of a messaging service centre associated with a messaging service centre interface or by way of a POI interface, the messaging service centre interface or POI interface, as applicable, operates to provide a copy of the mobile-phone based message to the message archiving server for storage.

3. A message archiving system according to claim 1, where each messaging service centre interface and each POI interface are in data communication with a temporary storage medium for the storing of the copies of the mobile phone-based messages, each temporary storage medium operable to forward the copies of mobile phone-based messages to the message archiving server at preset times.

4. A message archiving system according to claim 3, where each temporary storage medium has differing preset times at which it is to forward the copies of mobile phone-based messages to the message archiving server.

5. A message archiving system according to claim 1, where a user is designated a participating user following the communication of an opt-in message to the message archiving server.

6. A message archiving system according to claim 1, where the participating user is able to view copies of mobile phone-based messages related to the participating user, as stored by the message archiving server, through a website interface.

7. A message archiving system according to claim 1, where the participating user is able to view copies of mobile phone-based messages related to the participating user, as stored by the message archiving server, by way of a downloadable electronic file.

8. A message archiving system according to claim 1, where the participating user is able to view copies of mobile phone-based messages related to the participating user, as stored by the message archiving server, by way of an external application.

9. A message archiving system according to claim 1, where the mobile phone-based message is a short message service message or a multimedia message service message.

10. A message archiving system according to claim 1, where the copied mobile phone-based messages are sorted by the messaging service centres and POI interfaces.

11. A message archiving system according to claim 1, where the copied mobile phone-based messages are sorted by the message archiving server.

12. A message archiving system comprising:
a message archiving server;
at least one messaging service centre interface; and
at least one POI interface;
where, a copy of all mobile phone-based message by way of at least one messaging service centre associated with a messaging service centre interface or by way of at least one POI associated with a POI interface, are provided by the message service centre or POI interface, as applicable, to the message archiving server, the message archiving server thereafter operable to store only those messages for which a mobile phone number of a participating user is specified as the recipient.

13. A message archiving server in communication with at least one messaging service centre interface and at least one POI interface where, when a mobile phone number of a participating user is specified as the recipient of a mobile phone-based message by way of at least one messaging service centre associated with a messaging service centre interface or by way of at least one POI associated with a POI interface, the messaging archiving server receives for storage a copy of the mobile phone-based message from the messaging service centre interface or POI interface, as applicable.

14. A message archiving server in communication with at least one messaging service centre interface and at least one POI interface where, the message archiving server is operable to receive a copy of each mobile phone-based message from each messaging service centre interface and POI interface and, thereafter, operable to store only those messages for which a mobile phone number of a participating user is specified as the recipient.
